(19) United States
(12) Patent Application Publication
(10) Pub. No.: US 2006/0272014 A1
(43) Pub. Date: Nov. 30, 2006

(54) Gateway notification to client devices

(76) Inventors: Matthew B. McRae, Laguna Beach, CA (US); Kendra S. Harrington, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/139,170

(22) Filed: May 26, 2005

(51) Int. Cl. G06F 15/16

(52) U.S. Cl. 726/12

(57) ABSTRACT

A gateway device is provided, wherein the device is configured to initiate communication with a client device to notify the client device of detected network events and to query the user for action. A method of managing a gateway device is provided. The method includes: detecting an unauthorized network event, transmitting from the gateway device to a client device over a local area network (LAN) a message indicating the detection of the unauthorized or unexpected network event and requesting a response from a user of the client device, receiving the response from the client device, and handling the unauthorized or unexpected network event pursuant to the response from the client device.

### BACKGROUND OF THE INVENTION

In conventional home networks and small office/home office (SOHO) networks, a router is used to connect the local-area network (LAN) to a wide-area network (WAN), such as the Internet. To improve the ease of implementing a LAN, combination devices are sold that combine into a single device multiple network connectivity functions, such as a router, a switch, and a wireless access point (WAP). One such currently available combination device is the Wireless-G Broadband Router (Model WRT54G) by Linksys, a division of Cisco Systems, Inc., of San Jose, Calif. This combination device can then be connected to a cable or DSL modem in order to provide WAN connectivity to all devices on the LAN. In other combination devices, the modem function is also bundled with the router, switch, and WAP functions. One such currently available combination device is the Wireless-G Cable Gateway (Model WCG200) by Linksys.

Firewalls are commonly used in networked environments to prevent certain types of unauthorized network communications. These firewalls may be configured to intercept the data traffic at a gateway between two networks, to check the data packets, and to block unwanted traffic from entering or exiting the network. One type of firewall is a personal firewall, which filters network traffic for a single device, such as a personal computer (PC). Personal firewalls are typically implemented using a software application running on the PC to be protected. A second type of firewall is a hardware firewall, which typically runs on a gateway device positioned on the boundary between two networks, such as a router. Although personal software firewalls are useful for protecting an individual computer, these types of firewalls provide little or no protection for the rest of the LAN in which the computer resides. Therefore, hardware firewalls residing in gateway devices are preferable for providing network-wide protection. One limitation of implementing the firewall on the gateway device is that the gateway device generally does not have direct access to a user or administrator, such as through a computer monitor and keyboard.

As a result, administrators typically configure and manage the hardware firewalls provided by gateway devices by using a PC to access a gateway device management console interface either through a browser-based graphical user interface (GUI) hosted by the gateway device or a Setup Wizard application running on the PC. In either case, an administrator at a separate device must actively connect to the gateway device to perform the desired management functions. In many small network environments, particularly home networks, the user responsible for administration of the gateway device has little or no training in managing networks and may not understand all of the functionality provided by a router and firewall. Thus, the firewall may not be properly configured for the user's needs. Unfortunately, in conventional hardware firewalls, it is up to the administrator to take action by accessing the management console to make the necessary changes to the firewall configuration settings. As a result, the firewall will remain improperly configured, preventing the user from engaging in desired activities or, even worse, allowing dangerous network traffic into the LAN.

Accordingly, it would be desirable to provide a gateway device that provides improved communication with the user to enable the gateway device to be better configured for the user's needs.

### DESCRIPTION OF THE DRAWINGS

FIG. 1 is a block diagram showing a data communications network for operating a firewall, in accordance with embodiments of the present invention.

FIG. 2 is a flowchart illustrating a method of managing a gateway device, in accordance with embodiments of the present invention.

FIG. 3 illustrates an operational sequence chart for managing a gateway device, in accordance with embodiments of the present invention.

FIG. 4 illustrates an operational sequence chart for managing a gateway device, in accordance with other embodiments of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

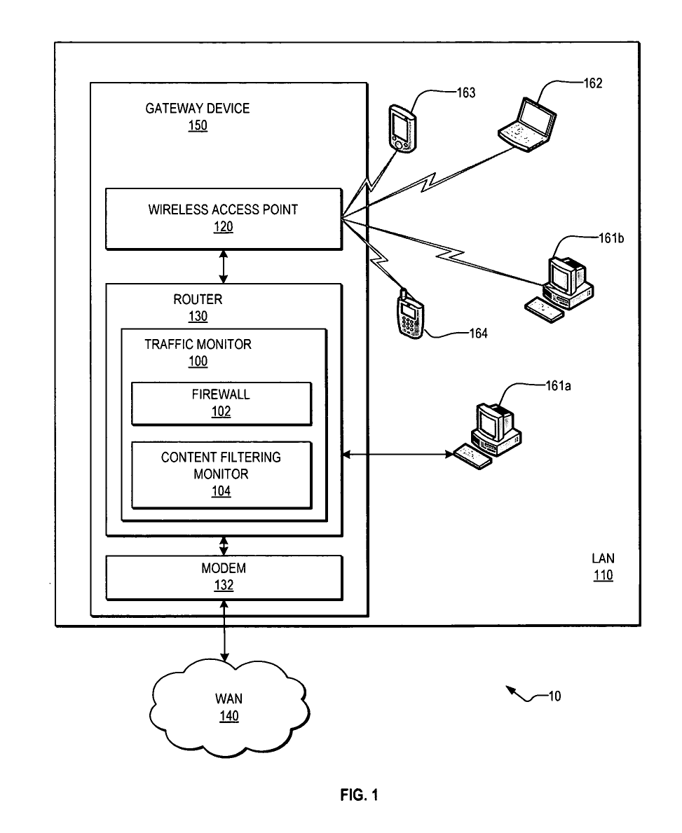

FIG. 1 is a block diagram showing an exemplary data communications network for managing a gateway device, in accordance with embodiments of the present invention. In the illustrated embodiment, the data communications network 10 comprises a local area network (LAN) 110 coupled to a wide-area network (WAN) 140, such as, e.g., the Internet.

The LAN 110 includes a gateway device 150, which may include multiple components. A gateway device is a device that connects LANs or segments of LANs, such as a repeater, hub, bridge, router, or switch. These gateway devices may operate in one or more of the physical, data link, and network layers of the network model. In the illustrated embodiment, the gateway device 150 comprises a router (and/or switch) 130 coupled to a modem 132 that provides an interface to the WAN 140. The gateway device further comprises a wireless access point (WAP) 120, which provides wireless network connectivity to the LAN 110 via a wireless local-area network (WLAN). The WLAN may comprise a wireless network compliant with the standards governed by, e.g., IEEE 802.11 (“WiFi”), IEEE 802.15.1 (“Bluetooth”), ultra wideband (UWB) radio, and the like.

In other embodiments, the gateway device 150 may comprise greater or fewer components. For example, the WAP 120, the router 130, and the modem 132 may be implemented as separate devices or combined together in other combinations (e.g., a combination WAP 120 and router 130 coupled to a separate modem 132).

Multiple devices may be connected to the LAN 110. For example, one or more personal computers (PC) 161a may be coupled to the router 130 via network cabling. In addition, other devices, such as, e.g., a second PC 161b, a laptop computer 162, a personal digital assistant (PDA) 163, and WiFi telephone 164, may be configured to wirelessly connect to the WLAN via the WAP 120. All of these devices may be located in the same facility, such as a personal residence for a home WiFi network.

Each PC 161 generally comprises a system unit, one or more input devices (e.g., a keyboard and a mouse), and a display. The system unit comprises one or more system buses, to which the central processing unit (CPU), memory, storage, and other components are coupled. The PC includes an operating system, which organizes and controls hardware and software, and provides services to application programs on the PC. Popular operating systems include the Windows OS (e.g., Windows XP) by Microsoft Corp. of Redmond, Wash., and the Mac OS (e.g., OS X) by Apple Computer, Inc., of Cupertino, Calif.

The router 130 comprises a network traffic monitor 100, which examines traffic passing through the router 130 and provides various network monitoring and security functions. In the illustrated embodiment, the traffic monitor 100 provides a firewall 102 and a content filtering monitor 104. In other embodiments, the traffic monitor 100 may provide additional networking monitoring functionality, such as, e.g., network security and event logging.

The firewall 102 comprises a hardware firewall that examines all inbound and outbound network traffic routed between the LAN 110 and WAN 140 to determine if the traffic meets certain criteria. The firewall 102 includes an access rules data structure for storing various rules and settings controlling the operation of the firewall 102. Based on the access rules defined by the access rules data structure, the firewall 102 either allows the traffic to pass through the gateway 150 or blocks the traffic. Two types of access denial methodologies may be used by the firewall 102. In the first method, the firewall 102 allows all network traffic through the firewall 102 unless the traffic meets certain criteria defined by the access rules. In the second method, the firewall 102 blocks all network traffic to a firewall 102, unless the traffic meets certain criteria defined by the access rules.

The firewall 102 may operate at one or more network layers to restrict network traffic. A packet filter firewall can be used to forward or block packets based on the information in the network layer and transport layer headers (e.g., source and destination Internet Protocol (IP) addresses, source and destination port addresses, and type of protocol (TCP or UDP)). The access rules data structure for a packet filter firewall comprises a filtering table which is used to identify the packets to be blocked. An application-level gateway (ALG) firewall filters network traffic at the application layer by examining the content of the traffic. A stateful firewall operates at multiple network layers and primarily examines the state or type of connection rather than inspecting every packet.

The content filtering monitor 104 can be used to prevent certain users and/or certain devices on the LAN 110 from accessing certain types of unauthorized web sites on the Internet. In one embodiment, the content filtering monitor 104 may comprise a Parental Controls monitor that prevents children from viewing web sites that may contain material inappropriate for children. In another embodiment, the content filtering monitor 104 may comprise a corporate filter used to prevent all corporate users on the LAN from accessing certain sites. For example, the content filtering monitor 104 may detect when an application on the client device (e.g., a browser application on PC 161b) attempts to access a web site that has previously been identified as inappropriate. The content filtering monitor 104 will block this attempt and may optionally transmit a message to the requesting application indicating that requested web site has been blocked.

As described above, the gateway device 150, including the firewall 102 and the content filtering monitor 104, may be managed using a management console provided by a browser or Setup Wizard application running on a PC connected to the gateway device 150. This arrangement typically depends upon the user to actively launch the management console application and select the appropriate settings for the gateway device 150. If the gateway device 150 is configured improperly, the various devices on the LAN may be prevented from performing as desired by the user. In many cases, an application on a client device may simply not function, and the user may be unaware that the firewall settings are responsible for preventing the proper operation of the application. This may significantly degrade the overall user experience and result in excessive technical support calls from users trying to “fix” their gateway devices.

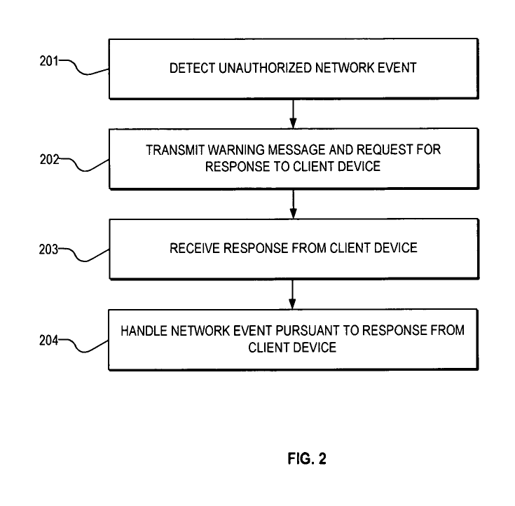

FIG. 2 is a flowchart illustrating a method of managing a gateway device, in accordance with embodiments of the present invention. This method allows the gateway device 150 to query a user at a client device on the LAN 110 to determine the correct action to take upon detection of potentially dangerous network traffic. In step 201, an unauthorized network event is detected by the traffic monitor 100 in the gateway device 150. In step 202, the gateway device 150 transmits a warning message to a client device. This warning message includes a request for a response from the user. In step 203, the gateway device 150 receives the response from the client device. In step 204, the gateway device 150 handles the network event pursuant to the instructions contained in the response from the client device.

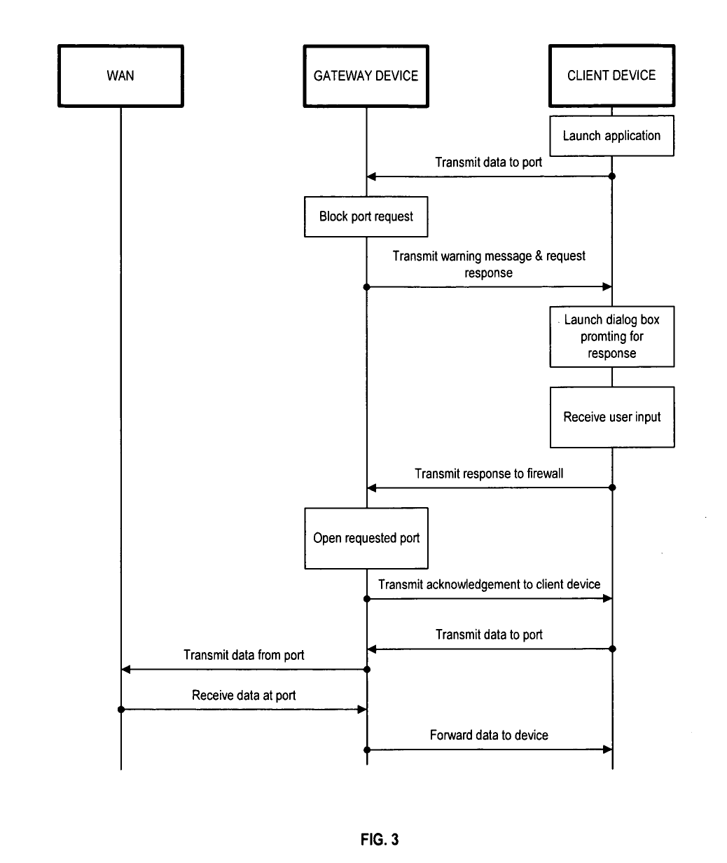

FIG. 3 illustrates an operational sequence chart illustrating a method of managing the gateway device 150 in FIG. 1, in accordance with embodiments of the present invention. First, an application is launched on a PC (e.g., PC 161b). This application attempts to transmit data on a particular port blocked by the firewall 102. When the firewall 102 detects this attempt to transmit data on the closed port, the firewall 102 will block the port request.

In contrast with conventional firewalls, which may simply silently block the attempted data transmission, the gateway device 150 will initiate communication with a user at a client device to determine whether the requested data transmission should be allowed. The gateway device 150 will transmit a warning message to the client device indicating that an unauthorized network event has been detected and requesting a response from the user at the client device.

This communication between the gateway device 150 and the client device can be performed in a variety of ways. For example, the gateway device 150 may use a simple notification protocol to communicate with a client application running on the client device. In one embodiment in which the client device comprises a PC running the Windows XP operating system, the client application may comprise a system tray utility application that launches at initial startup of the PC. By launching a simple client application at startup, the client application will be available to receive messages from the gateway device 150 at all times without consuming excessive memory resources.

In response to receiving the warning message from the gateway device 150, the client application on the client device will launch a dialog box to attract the user's attention. This dialog box will contain a description of the unauthorized network event detected by the gateway device 150 and prompt the user for a response.

The type of response prompted from the user may vary depending on the type of network event detected. For example, when the unauthorized network event comprises an attempt to transmit data on a port blocked by the firewall 102, the gateway device 150 may request that the user respond by selecting one of the following options: continue blocking the prohibited port, grant one-time access to the port for a single session, or grant full access to the port permanently. The user may indicate his or her selection by, e.g., clicking on the button corresponding to the desired course of action using the mouse input device for the PC.

Next, the client application transmits the user's response to the gateway device 150. In FIG. 3, the user's response was to allow full access to the port. In response to receiving the instructions from the client device, the firewall 102 in the gateway device 150 will open the requested port and update the access rules data structure of the firewall 102 to reflect the user's instructions. The gateway device 150 may also transmit an acknowledgment to the client device indicating that the response was received. The application on the client device again attempts to transmit data to the previously blocked port. The gateway device 150 forwards the data from the port to the destination on the WAN. Any incoming data on that port will also be received by the gateway device 150 and forwarded to the client device.

In accordance with embodiments of the present invention, various network monitoring functions of the gateway device can be managed more effectively. For example, the traffic monitor 100 may also be used for protection against malicious software (“malware”). Malware are software programs developed for the purpose of damaging or disrupting a computer system, such as a virus or trojan horse. When the traffic monitor 100 detects potential malware in network traffic, for example outgoing worm traffic as exemplified by a large quantity of emails from a single client in a short period of time, the traffic monitor 100 can transmit a warning message to the client device indicating the potential threat and requesting instructions from the user whether to allow or block the identified data. These embodiments may advantageously provide malware protection within the router or other gateway device, as opposed to conventional malware protection applications which only protect the individual node PCs on which the applications are loaded.

In the above described example, the unauthorized network event detected by the gateway device was initiated by the same client device to which the gateway device transmitted the warning message. In accordance with other embodiments of the present invention, the gateway device can detect an unauthorized network event initiated by a first client device and then transmit the warning message to a second client device, separate from the first client device. A user at the second client device can then instruct the gateway device on how to handle the detected network event.

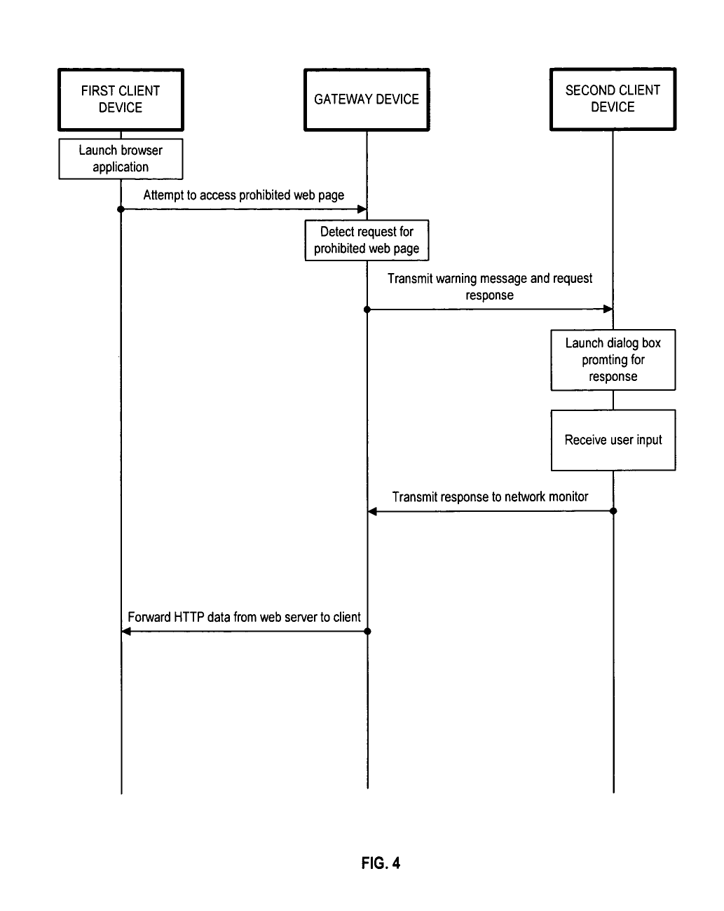

FIG. 4 illustrates an operational sequence chart illustrating a method of managing the gateway device 150 in FIG. 1, in which the gateway device detects an unauthorized network event initiated by a first client device, but requests instructions from a second client device. In this example, a user at the first client device (e.g., PC 161a) launches a browser application and attempts to access a web page prohibited by the content filtering monitor 104 in the gateway device 150. The content filtering monitor 104 detects this request for a prohibited web page and transmits a warning message to a second client device associated with a network administrator. The first client device may be the PC 161b located in a child's bedroom, and the second client device may be the PC 161a located in the parents' bedroom.

When the client application running on the second client device receives the warning message from the gateway device 150, the client application will launch a dialog box informing the user of the detected network event (e.g., the URL for the prohibited web page), and requesting that the user provide instructions to the gateway device 154 regarding how to handle the unauthorized network event. In this example, three options may be provided: allow access to the URL once, allow access to the URL permanently, or deny access to the URL. The client application receives the user input, and transmits the response to the gateway device 150. If access to the URL has been granted, the content filtering monitor 104 will retrieve the requested HTTP data from the web server and forward the HTTP data to the first client device. The instructions from the second client device can then be recorded in the access rules data structure for the content filtering monitor 104, so that future attempts to visit the URL can be allowed without further intervention from the second client device.

In the above described embodiment, the first client device and the second client device both comprise PCs. In other embodiments, these devices need not be personal computers. For example, the gateway device may be configured to transmit warning messages and requests for responses to a PDA 163 or a WiFi phone 164. Any device capable of receiving messages from the gateway device 150 and transmitting responses back to the gateway device 150 may be used.

In another example, the unauthorized network event may comprise an attempt by a new device to connect to the LAN 110. Thus, the gateway device may be used to transmit warning messages to inform a client device of the presence of the new device. This may be particularly useful in warning users of the detection of unauthorized devices attempting to access the WLAN 120, since this unauthorized access may be attempted by devices located outside of the physical structure housing the LAN 110. Many SOHO users do not properly protect their wireless networks and leave the networks open to unauthorized users located within wireless range of the WAP 120.

When the WAP 120 detects an attempt by a new device to access the WLAN 120, the gateway device 150 can transmit a warning message to a client device informing the user of the attempted access and requesting instructions for how to handle the event. The client device may choose to allow or deny the new device access to the WLAN 120.

In another example, the unauthorized network event detected by the gateway device may comprise detection that a predetermined bandwidth threshold or network delay threshold has been reached or is imminent. Thus, if an application on a first client device attempts to transmit or receive data through the gateway device 150, but other applications are consuming the available bandwidth at a level that would impact the application on the first client device, the gateway device 150 may transmit a warning message to the first client device. This warning message may inform the user at the first client device of the bandwidth usage, and may optionally identify the other applications and/or client devices that are consuming the available bandwidth. The user at the first client device may then choose to cancel the data transmission request, reattempt the data transmission, or override the other applications and prioritize the first client device's data transmission. This implementation may be particularly desirable when the application on the first client device is critical for quality of service reasons.

As described above, the gateway device may be configured to transmit a warning message to a client device in response to the detection of a particular network event. The client device to receive these warning messages can be designated in a variety of ways. In one embodiment, only a single client device in the LAN will run the client application for receiving messages from the gateway device. Thus, only that client device will receive the warning messages for all events.

Alternatively, if more than one client device is provided with a client application for receiving warning messages from the gateway device, then a notification procedure may be used to determine which client device to notify. In one embodiment, all client devices will receive notifications of all detected network events. In another embodiment, if the unauthorized network event is related to a particular client device (such as an attempt to transmit data to or from that client device), then only that client device would receive the warning message. In yet another example, a single client device may be identified as the administrator client device. The gateway device may be configured to notify the administration client device of all detected network events, all detected network events of a certain type, or all detected network events that are otherwise unrelated to any other client devices in the LAN.

The communication between the gateway device and the client device may be performed using a variety of communication protocols, such as, e.g., Extensible Markup Language (XML), Simple Network Management Protocol (SNMP), HyperText Markup Language (HTML), HyperText Transfer Protocol (HTTP), or Simple Object Access Protocol (SOAP). It may be preferable to utilize a simple communication protocol which allows for two-way communication between the gateway and client devices using simple communication applications, so that resource usage at the gateway and client devices can be minimized.

Embodiments of the present invention may provide various advantages not provided by prior art systems. For example, the gateway device is configured to initiate communication with a client device to notify the client device of detected network events and to query the user for action. This can allow the user to have more specific control over the home network, while using a simple dialog-box driven interface. Over time, any permanent changes to the access rules for the gateway device would help to fine tune the gateway device's performance and behavior to match the user's needs without requiring the user to log into the gateway device's management console and manually set the parameters.

In addition, this management system can assist users in configuring their routers even when the users lack expertise in network management. For example, most casual users would not know which ports are utilized for various applications. Therefore, even if the user did launch the router management console, the user would not know which port to open. However, in accordance with embodiments of the present invention, when a user launches an application (e.g., a video chat client) that utilizes a particular port that is currently blocked by the router, a warning message will be transmitted from the router to the client device identifying the requesting application and allowing the user to open the necessary port. Thus, the user is able to open ports based on the application being used, rather than by a particular port number. This helps to provide a more intuitive user interface and experience.

In many of the embodiments described above, the network event detected by the gateway device originates from some event occurring within the LAN. Because the gateway device is situated between the LAN and another network, such as the Internet, the gateway device may also be used to examine incoming data traffic to detect network events originating from outside the LAN. For example, if a device on the Internet attempts to initiate a web conference with a device within the LAN, the gateway device may detect this attempt and request authorization from a client device to permit this attempted communication. The client device may be provided with various options, such as, e.g., temporarily allow the communication, permanently allow the communication, deny the communication this time, and deny the communication permanently.

While the invention has been described in terms of particular embodiments and illustrative figures, those of ordinary skill in the art will recognize that the invention is not limited to the embodiments or figures described. For example, in many of the embodiments described above, the gateway device is implemented in a home network environment. In other embodiments, the gateway device may be implemented in large-scale enterprise environment.

In addition, in the embodiment described above with respect to the FIG. 3, the firewall 102 is used to detect unauthorized attempts to access a particular port. In other embodiments, the firewall 102 may detect unauthorized network events occurring at other network layers. The types of unauthorized network events detected by the traffic monitor 100 may vary, depending on the needs of the network environment.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of managing a gateway device, comprising:
detecting an unauthorized network event;
transmitting from the gateway device to a client device over a local area network (LAN) a message indicating the detection of the unauthorized network event and requesting a response from a user of the client device;
receiving the response from the client device; and
handling the unauthorized network event pursuant to the response from the client device.

2. The method of claim 1, wherein:
said gateway device comprises a router.

3. The method of claim 1, wherein:
said detecting the unauthorized network event comprises detecting network traffic prohibited by a firewall in the gateway device.

4. The method of claim 3, wherein:
said handling the unauthorized network event comprises updating an access rules data structure of the firewall.

5. The method of claim 3, wherein:
said unauthorized network event comprises an attempt to access a port blocked by the firewall.

6. The method of claim 5, wherein:
said requesting the response from the user of the client device comprises requesting the user to select an action from the list of actions comprising: continue blocking the port, temporarily allowing the network traffic through the port, and permanently allowing the network traffic to the port.

7. The method of claim 3, wherein:
said detecting the unauthorized network event comprises detection of potential malware in network traffic through the firewall.

8. The method of claim 7, wherein:
said requesting the response from the user of the client device comprises requesting the user to select an action from the list of actions comprising: allow the network traffic and block the network traffic.

9. The method of claim 1, wherein:
said detecting the unauthorized network event comprises detecting an attempt at a first client device to access a prohibited web page; and
said transmitting to the client device comprises transmitting to a second client device the message indicating the detection of the unauthorized network event and prompting the user of the second client device for the response.

10. The method of claim 1, wherein:
said gateway device comprises a wireless access point (WAP); and
said detecting the unauthorized network event comprises detection of a new client device attempting to access the WAP.

11. The method of claim 10, wherein:
said requesting the response from the user of the client device comprises requesting the user to select an action from the list of actions comprising: block the new client device from accessing the WAP and allow the new client device to access the WAP.

12. The method of claim 1, further comprising:
executing on the client device a traffic monitoring application for receiving messages from the gateway device, for prompting the user to submit the response, and for transmitting the response to the gateway device.

13. A gateway device, comprising:
a first network interface for communicating with a first network;
a second network interface for communicating with one or more client devices on a second network; and
a traffic monitor configured to monitor network traffic through the gateway device and in response to detecting an unauthorized network event, to transmit to a client device a message indicating the detection of the unauthorized network event and requesting a response from a user of the client device, wherein the traffic monitor is further configured to handle the unauthorized network event pursuant to the response from the client device.

14. The device of claim 13, wherein:
said gateway device comprises a router.

15. The device of claim 13, wherein:
said detecting the unauthorized network event comprises detecting network traffic prohibited by a firewall in the gateway device.

16. The device of claim 15, wherein:
said traffic monitor is configured to handle the unauthorized network event by updating an access rules data structure of the firewall.

17. The device of claim 15, wherein:
said unauthorized network event comprises an attempt to access a port blocked by the firewall.

18. The device of claim 17, wherein:
said traffic monitor is configured to request the response from the user of the client device by requesting the user to select an action from the list of actions comprising: continue blocking the port, temporarily allowing the network traffic through the port, and permanently allowing the network traffic to the port.

19. The device of claim 15, wherein:
said detecting the unauthorized network event comprises detection of potential malware in network traffic through the firewall.

20. The device of claim 19, wherein:
said traffic monitor is configured to request the response from the user of the client device by requesting the user to select an action from the list of actions comprising: allow the network traffic and block the network traffic.

21. The device of claim 13, wherein:
said detecting the unauthorized network event comprises detecting an attempt at a first client device to access a prohibited web page; and
said traffic monitor is configured to transmit to the client device the message indicating the detection of the unauthorized network event by transmitting to a second client device the message indicating the detection of the unauthorized network event and prompting the user of the second client device for the response.

22. The device of claim 13, wherein:
said gateway device comprises a wireless access point (WAP); and
said detecting the unauthorized network event comprises detection of a new client device attempting to access the WAP.

23. The device of claim 22, wherein:
said traffic monitor is configured to request the response from the user of the client device by requesting the user to select an action from the list of actions comprising: block the new client device from accessing the WAP and allow the new client device to access the WAP.

24. The device of claim 13, wherein:
said traffic monitor is configured to execute on the client device a traffic monitoring application for receiving messages from the gateway device, for prompting the user to submit the response, and for transmitting the response to the gateway device.

25. A gateway device, comprising:
a first network interface means for communicating with a first network;
a second network interface means for communicating with one or more client devices on a second network; and
a traffic monitoring means for monitoring network traffic through the gateway device and for transmitting to a client device a message indicating detection of an unauthorized network event and requesting a response from a user of the client device, wherein the traffic monitoring means is further configured to handle the unauthorized network event pursuant to the response from the client device.
